(19) United States
(12) Patent Application Publication
(10) Pub. No.: US 2011/0238189 A1
(43) Pub. Date: Sep. 29, 2011

(54) Method and Apparatus for Controlling a Plant Using Feedback Signals

(76) Inventors: William J. Butera, Cambridge, MA (US); William S. Yerazunis, Acton, MA (US)

(21) Appl. No.: 12/732,887

(22) Filed: Mar. 26, 2010

(51) Int. Cl. G05B 13/04; G05B 15/02; G05B 13/02

(52) U.S. Cl. 700/30; 700/87; 700/33; 700/32

(57) ABSTRACT

A method and apparatus controls a plant using feedback signals. A procedural description of a feedback control process for the plant is translated into a set of objects, wherein each object is a portion of the procedural description, wherein each object is a strictly-encapsulated and autonomous software module, wherein the objects execute in a platform, and wherein the platform includes a set of nodes embedded in the plant and each node includes a processor. A feedback signals is generated by passing messages between the set of the objects in response to an operation of the plant.

### FIELD OF THE INVENTION

This invention relates generally to distributed processing, and more particularly to controlling complex physical plants in response using feedback signals.

### BACKGROUND OF INVENTION

Controlling dynamic physical systems (plants) with feedback signals is a foundational technology in engineering applications. One technique uses a control law based on models of the plants. The control law is a procedural description of a feedback control process. Here, a subset of states of the plant that can be controlled is limited to that portion of the state space that can be effectively modeled, i.e. one cannot control what is not modeled.

Improvements in a performance of feedback controllers, in terms of stability, reliability, and range of dynamic operation, are realized by increasing a number and complexity of the models, which is necessarily bounded, and often a limiting factor in the computational capacity of the controller. In applications where the control law is implemented as concurrent processes on a set of networked processors, this limit translates to a limit on efficient concurrency of operation.

The concepts and nomenclature used in this specification are drawn from three technologies that do not typically converge in a single field of prior art technology: parallel computing architectures; programming models based on multi-agent systems; and networked embedded control systems.

The following common terms and abbreviations are also defined:

| | |
|---|---|
| HW | abbreviation for hardware; |
| SW | abbreviation for software; |
| FM | abbreviation for firmware; and |
| platform | an environment in which the HW and SW operates. |

The platform can be a set of nodes connected by a network. Typically, each node includes a processor, memory, and input, output network interfaces for passing messages over the network.

Distributed Programming

In the field of distributed systems, concurrent programming for high degree-of-freedom (DOF) platforms remains an unsolved problem. For small clusters of reliable computing elements, there are a variety of engineering approaches that support a broad spectrum of applications, e.g., structured dataflow on a homogeneous mesh.

However, as the DOF increases, explicit centralized control of key functionality, such as sequencing, resource allocation, error management, is required. Use of these centralized functionalities limits the dimensionality of the platform to one for which the node can anticipate every likely permutation of processor failure and network congestion, and be ready with a bounded response, all under applicable real time constraints. Therefore, the centralized control imposes a hard upper bound on the allowable degrees of parallelism.

An alternative to centralized control is to use self-configuring SW. Self-configuring SW is a type of multi-agent system where the functionality of a global node is realized as an emergent operation of locally interacting autonomous agents. There are known engineering tools that can translate a quantitative description of the feedback control process for a desired global operation into a set of rules that govern unsupervised interaction among the autonomous agents. The condition on these rules is that the emergent global function is reliable when subject to variation in the local interactions, e.g., sequencing, packet loss, and node failure. This approach is often embodied as a constraint optimization procedure. Given a desired global state, a cost function is defined on the state space, and the local interactions are defined so as to optimize the cost function.

In practice, a set of nodes, which are distributed in the plant, can communicate with each other to coordinate the operation of the plant. A crucial characteristic of a conventional structure is that a distance between the nodes is large compared to physical phenomena that influence the operation of the plant. For example, if the plant is subject to mechanical vibration with a characteristic wavelength γ and propagation speed β, then the nodes are designed to dampen the vibration. However, the spacing between the nodes is usually much larger than the wavelength, and the bandwidth of the network is slower than the propagation speed of the phenomena, see e.g., U.S. Pat. No. 6,736,015 issued to Repperger et al. on May 18, 2004, “Robust Wireless Microelectro Mechanical System (MEMS) Shear Force Sensor.” It is desired to overcome these limitations of the prior art.

### SUMMARY OF THE INVENTION

The embodiments of the invention provide an apparatus (platform) and method for controlling a dynamic physical system (plant) using feedback signals.

The platform includes a network of multiple-input, multiple output (MIMO) nodes embedded in the plant. The networked nodes are treated as a distributed high degree-of-freedom (DOF) platform.

The method of this invention is the application of a process self-assembly (PSA) model to encode a model-based adaptive feedback control procedure for execution on the distributed platform.

The control procedure is implemented as an ensemble of strictly-encapsulated, autonomous objects (saObjects), which spatially distribute themselves during operation of the platform and plant. By casting a control law and System ID as a parallel workload, the advantages of the PSA model, e.g., portability, scale invariance, and error resilience, are extended to the domain of adaptive control on MIMO platforms.

This enables the platform to treat computing as an ‘elastic’ quantity. Namely, for a given control procedure, the requisite compute load is matched by scaling up the number of networked nodes. For adaptive control on MIMO platforms, this indirectly ties the performance of the controller to the number of nodes in the networked MIMO platform. Continued progress in reducing the size of integrated circuits makes this linkage a key enabler.

The ‘elasticity also has important consequences for cases when distances between the nodes, i.e., the spacing, and network delay is relative small when compared to a length scale of the dynamics of the plant. As the computational degrees of freedom of the platform become comparable to the mechanical degrees of freedom of the plant, the state space in which the platform operates can be extended to include partial control over bulk material properties of the plant. This extension of the operating domain of the platform is both novel and potentially very powerful.

Some example applications where the invention can be used include space systems with a lightweight satellite frame that is reliable when subject to stress at launch, or a crane-arm with programmable strength. Building can be reinforced to provide dynamic load capacity in response to earthquakes. Also, vehicles can be constructed to channel collision energy to the exoskeleton.

### BRIEF DESCRIPTION OF DRAWINGS

FIG. 1 is a block diagram of a platform for controlling a plant according to embodiments of the invention;

FIG. 2A is a block diagram of a three nodes linked in a 1D network;

FIG. 2B is a block diagram of a procedural description of a single-threaded feedback control process for the nodes of FIG. 2A;

FIG. 2C is a flow diagram of a single-threaded process of FIG. 2B;

FIG. 2D is a block diagram of a feedback control process according to embodiments of the invention;

FIG. 2E is a schematic of a strictly-encapsulated autonomous software objects (saObject) according to embodiments of the invention;

FIG. 2F is a flow diagram of an operation of the saObject of FIG. 2E according to embodiments of the invention;

FIG. 2G is a schematic transferring saObjects from an initial random distribution to a final distribution according to embodiments of the invention;

FIG. 3A is a block diagram of a cascade of three processors with inhomogeneous compute capacities according to embodiments of the invention;

FIG. 3B is a block diagram of a distribution of saObjects when optimized for throughput according to embodiments of the invention;

FIG. 3C is a block diagram of a distribution of saObjects when optimized for latency according to embodiments of the invention;

FIG. 4A is a block diagram of an operation of model-based adaptive controller according to embodiments of the invention;

FIG. 4B is a block diagram of SISO node according to embodiments of the invention;

FIG. 4C is a block diagram of a networked MIMO node according to embodiments of the invention;

FIGS. 5A-5C are schematics of deflection responses for a vertical column undergoing an axial load controlled according to embodiments of the invention;

FIG. 6 is a block diagram of a node according to embodiments of the invention;

FIG. 7 is a block diagram of a platform embedded in a plant according to embodiments of the invention;

FIG. 8 is a schematic of controller and a matrix representation of a proportional-integral-derivative control law according to embodiments of the invention;

FIG. 9 is a graphical model of the PID control law (feedback control process) according to embodiments of the invention;

FIG. 10 is a schematic of the PID control law encoded as saObjects according to embodiments of the invention;

FIG. 11 is a block diagram of a platform of nodes with an initial distribution of saObjects according to embodiments of the invention;

FIGS. 12A-12B are schematics of an initial and final arrangement of a plant according to embodiments of the invention;

FIG. 13 is a block diagram of a model selection procedure according to embodiments of the invention; and

FIG. 14 is a schematic of a distributed model selection procedure according to embodiments of the invention.

### DETAILED DESCRIPTION OF THE PREFERRED EMBODIMENTS

The embodiments of our invention provide an apparatus and method for controlling a dynamic physical plant using feedback signals, The apparatus in a form of a platform 103 including a set of nodes 101 and the dynamic physical system is a plant 700. The platform is embedded in the plant in a distributed manner, and the plant is subject to physical phenomena.

Each node includes a set of sensors (S) 610 to measure the physical phenomena, a set of actuators (A) 620 to change an operation of the plant in response to the physical phenomena, and a processor 630 connected to the set of sensors and the set of actuators. The node also includes a transceiver 640, memory 631, and a power source 640, all described in greater detail below.

The processor receives input signals from the set of sensors, and in response generate output feedback control signals for the set of actuators. The transceiver relays message between the nodes to coordinate an operation of the set of nodes. A size and density of the set of nodes correspond to the physical phenomena, and a speed at which the input and output signals are processed is greater than a speed at which the phenomena propagate though the plant.

Example plants can include a machines, buildings, large scale environments, vehicles, planes, boats, satellites, or bulk materials such as cement and steel, and possible combinations thereof

Computing Architectures

Parallel computing architectures can be grouped into two basic classes based on the method of inter-process communication:

shared-memory multiprocessors; and

message-passing systems.

Of particular interest to the invention are message passing platform, wherein data exchanged between nodes are encoded as message for transmission over a network connecting the nodes. Parallel architectures of this type have distinct, structural, cost, performance, and usage characteristics.

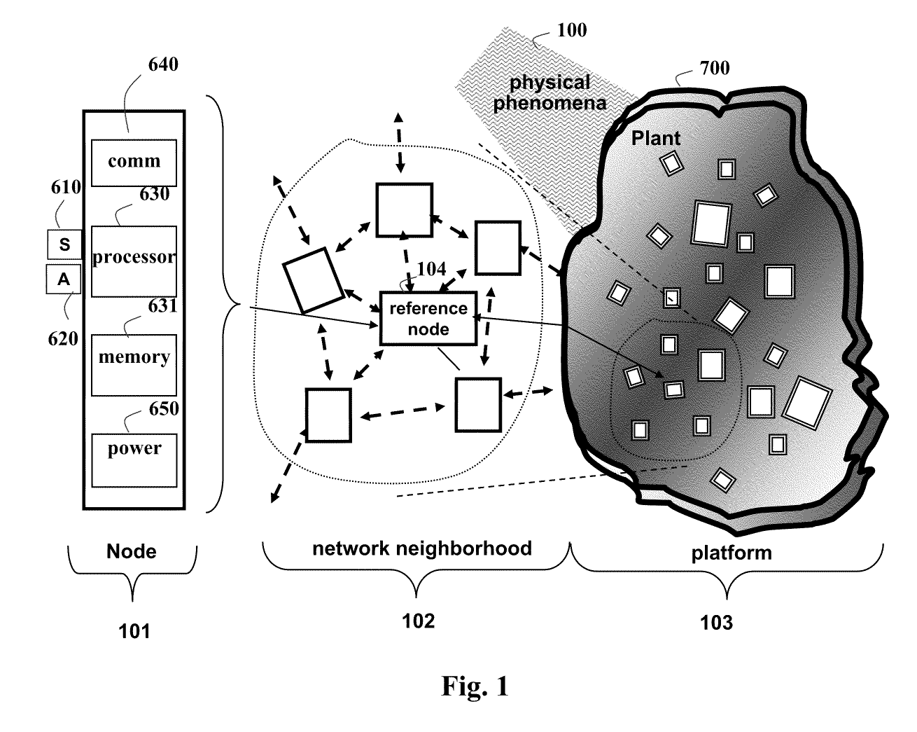

As shown in FIG. 1, the characteristics can be defined at three scales, a node 101, a network neighborhood 102, and a platform 103. The platform 103 is impeded in the plant 700.

Nodes

The nodes can be monolithic computing elements, or a single processing thread executing on a multi-threaded processor. The nodes include the processor 630 connected to the set of sensors (S) 610, the set of actuators 620, the communication interface 640 including the transceiver, the memory, and the power source 650. As defined herein, the sets of sensors and actuators can include any number of elements, including none (the null set).

Salient characteristics of the nodes include spatial size (footprint), compute capacity, memory capacity, network bandwidth, battery life-time, and mean time to failure.

Network Neighborhood of Nodes

The nodes are organized as follows. For a particular reference node 104, the network neighborhood nodes 102 is a subset of the set of nodes with direct (one hop) communication links to the reference node in the subset. The characteristics of the network neighborhood include a degree of synchrony, bandwidth, message protocols, and a spatial size of the links, e.g., centimeter-scale wireless links.

Platform

The platform is an aggregate of all the nodes. At this scale, the salient characteristics include a number of nodes, an interconnect hierarchy, and network topology, e.g., node placement, node density, node regularity, and interconnectivity configuration.

Each of these salient characteristics can be regarded as a dimension along which a given architecture of the platform is defined. A degree-of-freedom (DOF) is a qualitative metric for a variance along one or more of these dimensions, which can be a mechanical DOF and information DOF. The variance can be either spatial or temporal.

For example, if all the nodes of the platform use the same microcontroller, there are fixed values for an instruction architecture, clocks speed, and memory. Here, the DOF for the node dimension is near zero. In a platform where the nodes have a short mean-time-to-failure, the DOF is relatively high for the size of the network neighborhoods and for the topology of the platform. A maximal value for the DOF corresponds to an unconstrained system where, at all levels, the characteristic values are selected at random.

A high DOF platform refers to the target class of parallel computing platforms according to embodiments of the invention. Of particular interest are platforms where the nodes are relatively small, e.g., millimeter scale or less, and arrangement of the nodes is relatively dense, e.g., tens or millions of nodes spaced at a scale centimeters or less so that the mechanical degrees of freedom become comparable to the informational degrees of freedom.

The invention pertains to the entire architectural class of message passing systems. However, the preferred embodiments focus on a specific range of values for each characteristic. In this target class of parallel computing platforms, the processors are single monolithic microcontrollers, e.g., 16-32 bit processors with clock speeds on the order of 10⁸ Hz and a sub-cm² footprint. The network neighborhood has a length-scale that ranges from 10⁻² meters up to 10² meters. Communication is asynchronous using links with bandwidth in the range of 10⁴ to 10⁸ bytes per second. At the platform level, node placement is pseudo-random and time-varying. The number of nodes are in a range from 10¹ to 10⁶. A hierarchy of the network has what is known in the art as a flat topology. The mean time to failure of a single node is on the order of 10⁵ minutes divided by the number of nodes.

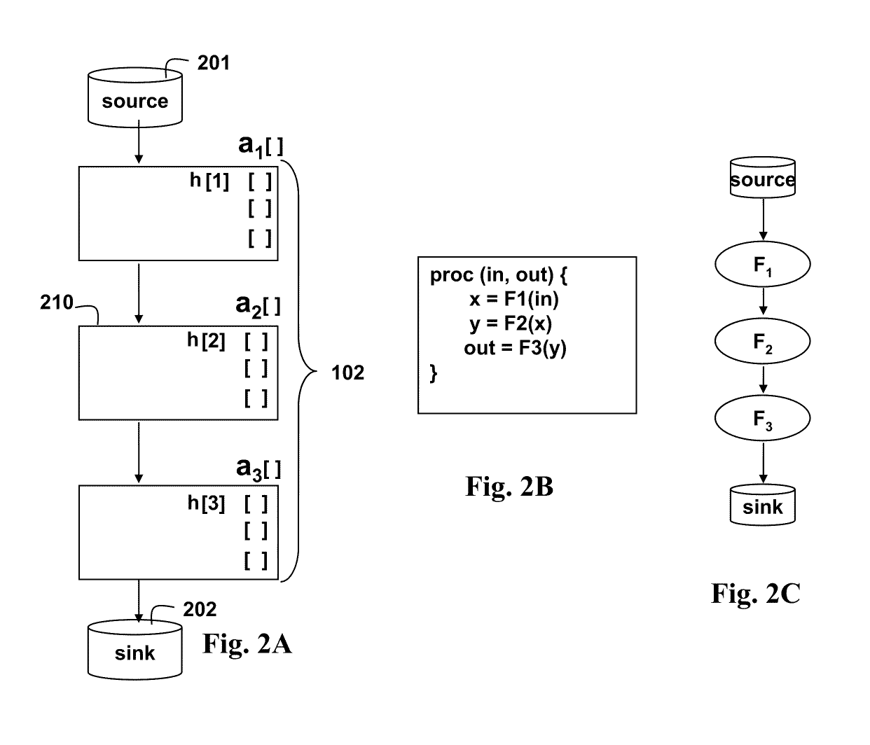

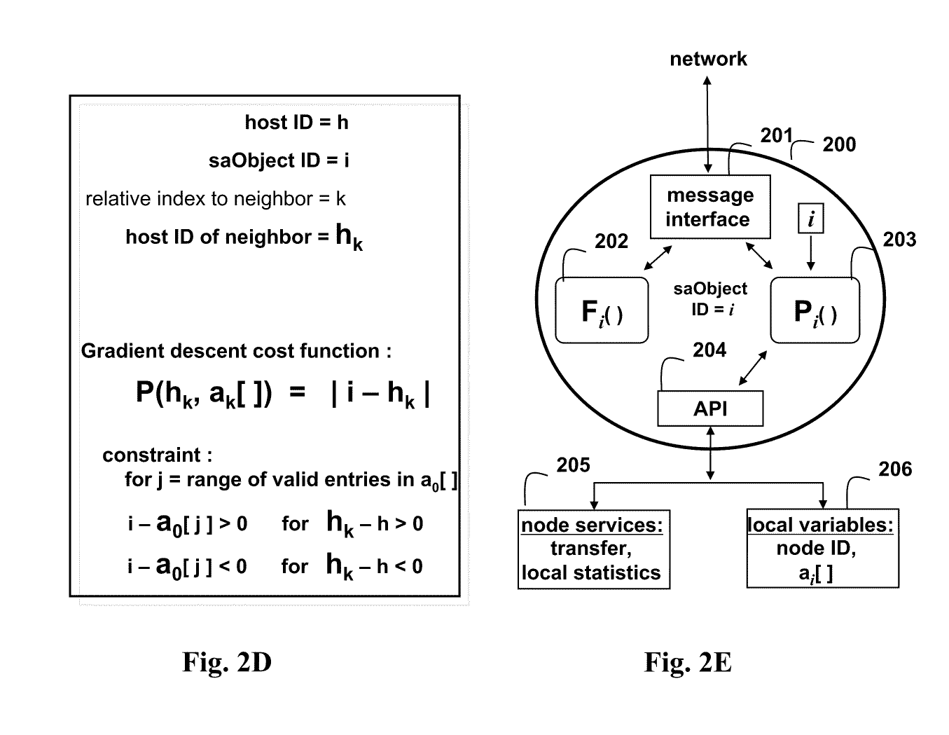

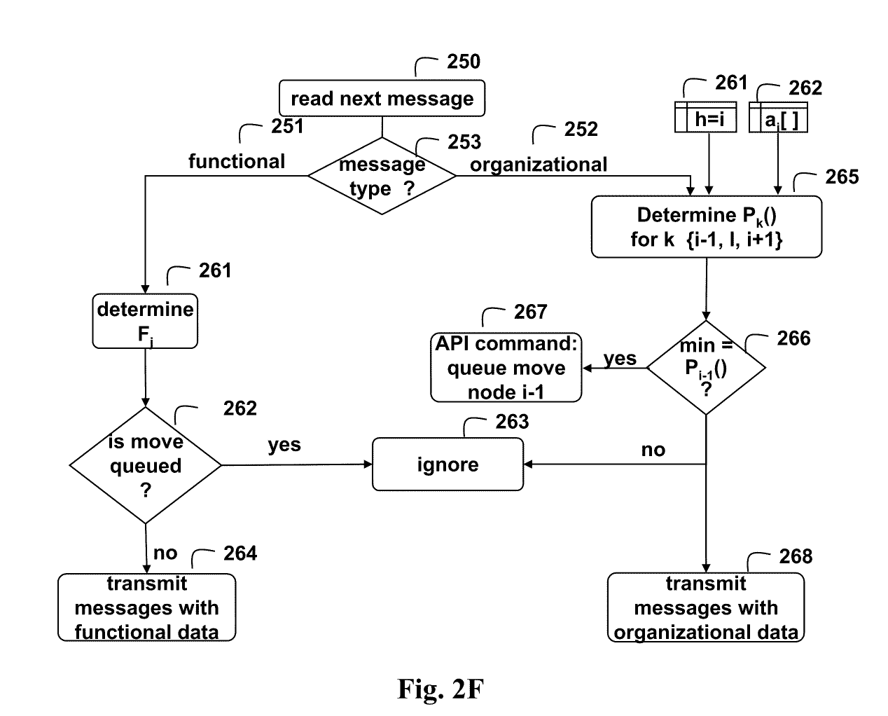

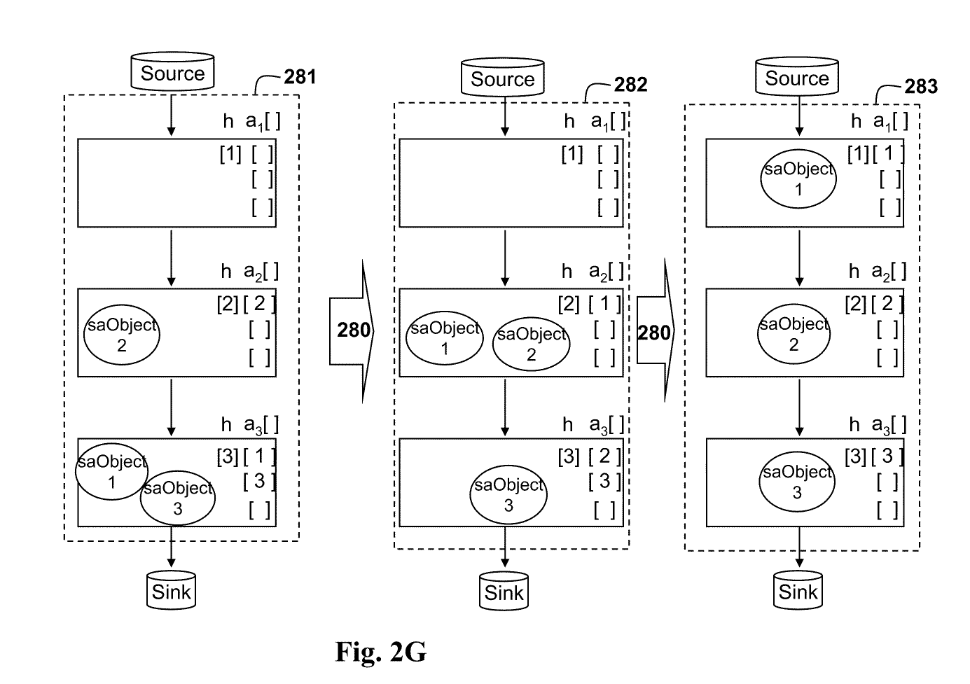

FIG. 2A shows a conventional example single threaded sequential procedure implemented as an ensemble of objects (saObjects) to be executed by the processors. The objects are strictly-encapsulated SW modules that can autonomously transfer throughout the network and communicate via the messages.

In the context of a process self-assembly (PSA) model, we defined “autonomous” colloquially. Autonomous means that the saObjects execute key functions without any external direction. In the field of computer science, the most common illustrative example are “active messages”; message packets that contain both data and executable code. After the message enters a routing node, the executable code in the message is used to decide where the message goes next.

In the pure form, the phrase “strictly encapsulated” refers to software modules where all methods and state data are contained within the object. Because the object is “strictly encapsulated,” the object can be placed anywhere in the network and still have a defined set of behaviors that is matched to its current environment.

In order to transfer the saObjects among the nodes, the following commands can be used, “transfer request”, “transfer accepted”, “transfer refused”, “install saObject” and “de-install saObject”. For example, the saObject initiates a transfer request with an index of the target node as a parameter. The target node responds with a “transfer accepted”. The saObject moves to a transfer queue on the host node, and de-installs itself when the transfer is complete. On completion, the target node executes saObject's install function.

Constraint optimization is used to arrange the saObjects over the set of nodes to optimize a performance of the platform in accordance with selected performance criteria

In FIG. 2A, three nodes 210 are connected as a 1D network from a source 201 to a sink 202. Each node is assigned an index h, i.e., labels h₁, h₂, h₃. The source is labeled h₀, and the sink is labeled h₄. Each nodes maintains an array a_{h[.]} that stores an identification (ID) of any saObject currently queued for execution within the node. The network scope of these variables is the network neighborhood of nodes 102, i.e., from any given node, the index number of the immediately neighboring nodes and the contents of the array a_{h[.]} from that neighboring node are known. Input/ouput (I/O) ports cannot store saObjects, and therefore are not associated with any array a_{h[.]}.

FIG. 2B shows an example simple single-threaded procedure, proc (in, out), of functions {F₁-F₃}. The goal is to compile this procedure for efficient execution on the networked neighborhood 102.

FIG. 2C expands this procedure into a flow diagram and labels the functions.

FIG. 2D shows a gradient descent cost function P(hₖ, a_{k[ ]})=|i−hₖ| for neighboring node k (current node corresponds to k=0), along with the constraints for the optimization of performance.

FIG. 2E shows an operation of an example saObject 200 assembled from the functions of FIG. 2C. The saObject includes a message interface 201, function 202-203, an application program interface 204, which provide node services 205 and processes local variable 206.

FIG. 2F shows the operations of the saObject. Messages 250 from the neighboring nodes are directed toward one of two distinct processing paths; a functional path 251, or organizational path 252, depending on a message type 253. The functional path corresponds to the execution path of the threaded procedure of FIG. 2B.

In this path, the function F is determined 261, and a decision 262 is made to queue the result, or not. If queued, then a message 264 with the functional data can be transmitted 263, otherwise the message 250 if ignored 263.

The organizational path manages the placement of the saObjects on the platform. Organizational messages contain the values of the state variables h 621 and a_{h[.]} 622 from the neighboring nodes. From the variables, the node determines 165 an updated value P(.) for itself, and each of the (one or) two neighboring nodes.

The arrangement of the saObjects is implemented according to the constrained gradient descent cost function P( ). If 266 a minimum value of P(.) corresponds to a neighboring node, the saObject uses an API commands 267 of the local node to queue itself for transfer to this neighboring node. As a part of the transfer, both the current node, and the new node update the contents of their respective arrays a_{h[.]}. The transfer operation 280 has converged when the local value of the cost function is minimized for all the saObjects, see FIG. 2G.

In actual practice, ensembles of “infrastructure” saObjects cooperate to analyze an operation, structure and performance of the platform, such as compute capacity, free storage, and network bandwidth. The postings of this discrete performance data form a numeric field that application-level saObjects use to optimize the transfer 280 of the saObjects from an initial distribution, via intermediate distribution(s) 282 to a final distribution as shown in FIG. 2G.

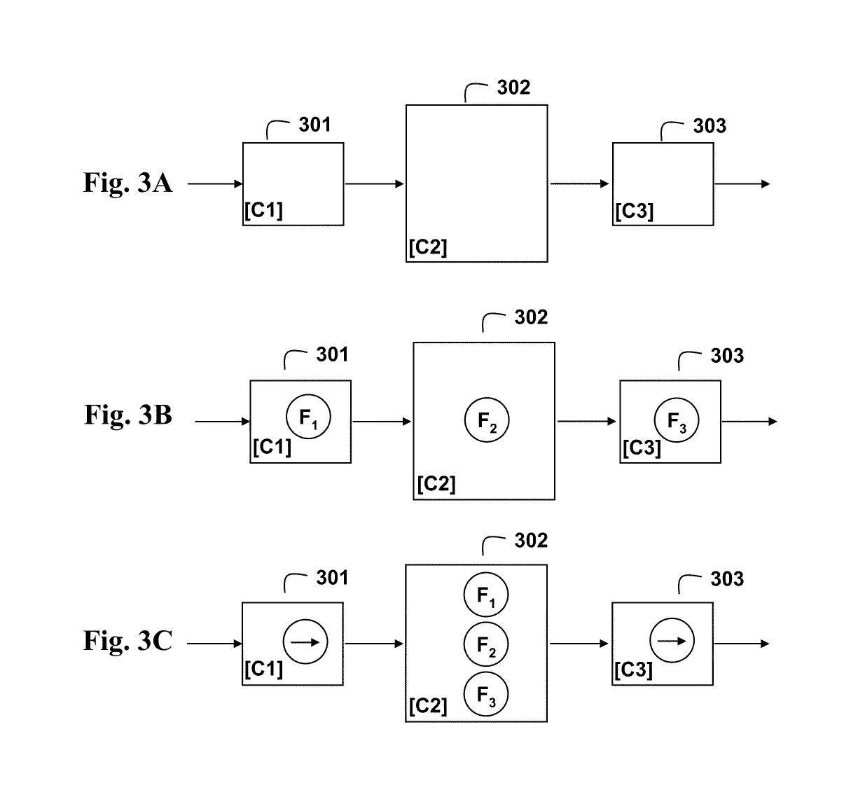

FIG. 3A shows how a concurrency of a procedure embodied as three saObjects can be optimized for either latency, or throughput. In this example, the computing platform is a cascade of three nodes 301-302, wherein a relative compute capacity is defined as

$${C}_{1} = {C}_{3} = ( \frac{2}{3} ) {C}_{2}$$

which is analogous to the case where the clock speed of the middle node 302 is 50% greater than the clock speed of the other two nodes. Infrastructure saObjects measure a relative determine the capacity of each node as locally readable variables. Starting from a random initial placement, the three saObjects transfer and distribute themselves to optimize for latency or throughput.

FIG. 3B shows the final placement of the nodes when a cost function F is defined to maximize throughput. Throughput, i.e., a rate at which data are processed, is maximized when the workload is balanced across all the nodes of a parallel system.

FIG. 3C shows the final placement when the cost function minimizes latency. In this case, latency, i.e., a total delay from source to sink, is optimized when the three saObjects execute sequentially on the fastest node, and the saObjects on the other nodes simply pass the data forward.

While ill-suited for low degrees of concurrency, self configuring SW becomes enabling as the number of networked heterogeneous nodes exceeds hundreds, with an attendant variability in placement, performance and reliability. At the point in system scaling when centralized control saturates and fails, alternatives based on decentralized control can continue to enable reliability of the high DOF platform.

For purposes of this specification, we define the PSA model as any programming model in which application SW is embodied as ensembles of the saObjects. The saObjects are strictly-encapsulated processes that communicate via message passing and autonomously transfer and rearrange themselves within a set of networked neighborhood nodes. The ensembles of saObjects spatially self-organize into stable virtual aggregates. The spatial distribution of the saObjects can be optimized for selected performance criteria, such as throughput, latency, memory size, and redundant execution. Applications embodied as ensembles of the saObjects exhibit portability, performance scaling, and resilience to variances in computing topology. Concurrency management is well matched to high DOF platforms.

Feedback Control

Generally, a feedback control system is one where a controller manipulates input variables of the dynamic physical system (the plant) in response to a set of output variables acquired by the sensors embedded in the plant. The input-output relationship of the nodes is defined by a control law. The control law is a procedural description of a feedback control process for the plant. Within a specified operating range, the control law ensures the stability of the plant by maintaining the output variables within pre-defined bounds.

Adaptive Control

In adaptive control, the control law adapts to internal and external dynamics of the plant. This can be done by partitioning the state space of the plant into multiple sub-regions, specifying a characteristic set point for each sub-region, and designing the control law for each set point.

During operation of the platform and the plant, adaptive nodes solve the dual problem of identifying the set points (System ID), and implementing the corresponding control law, i.e., the control law that is the procedural description of the feedback control process for the plant. In model-based adaptive control, the System ID phase estimates a current state of the plant using a parameterized computational model. The control law then operates on this model.

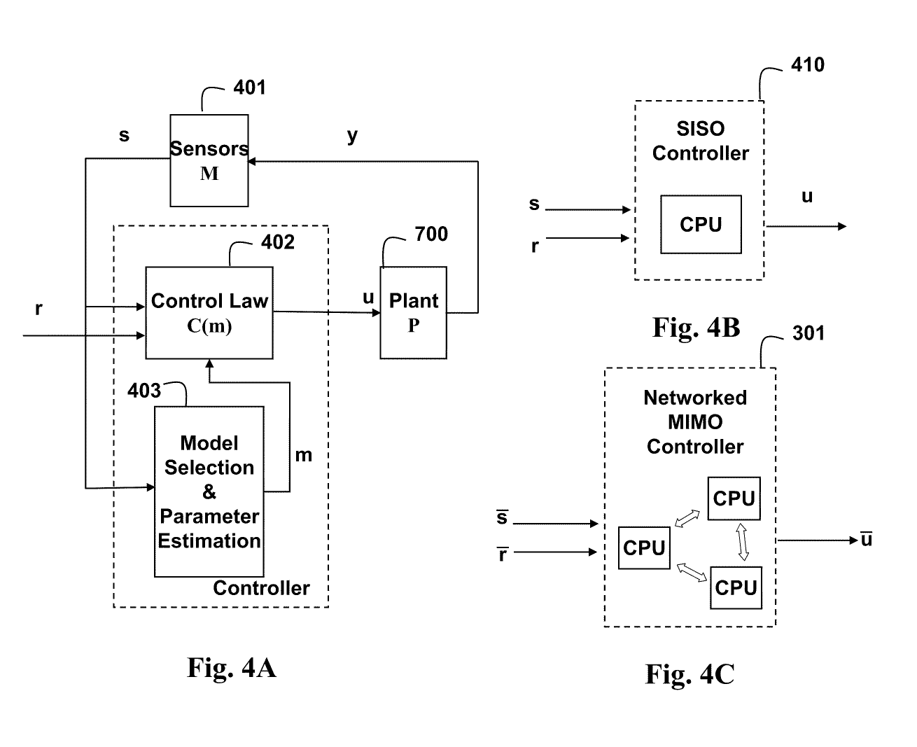

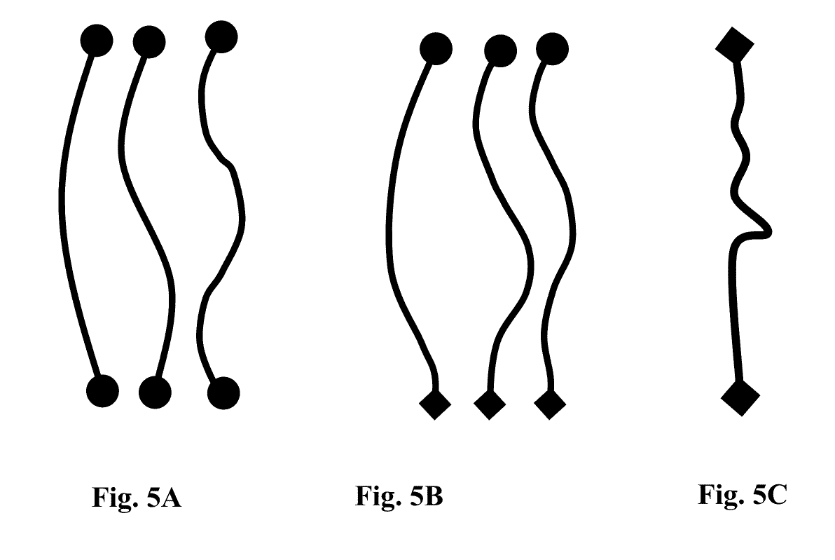

FIG. 4A shows a model-based adaptive controller. Sensors M 401 sample the state y of the plant 400 to produce a variable s. The control law 402 is applied to s. System ID operation 403 to generate m based on the variable s. Then, the model-specific control law 401 compares the variable s to a reference signal r to produce a set of control values u as feedback to the plant 700. The control procedure can be implemented as a binary procedure operating on the variable r and s.

As shown in FIG. 4B, nodes, where r, s, and u are scalar values, are referred to as single input, single output (SISO) nodes, which are typically implemented on single-threaded processors 410.

FIG. 4C shows instances when r, s, or u become vectors correspond to multiple input, multiple output (MIMO) nodes. For a variety of reasons, it is often impractical to route the multiple input and output variables as analog signals between the plant and a single monolithic nodes. Examples of this include MIMO nodes spread over large factories, or on aircraft where weight is at a premium. In such cases, MIMO nodes are implemented as networked nodes where the computation is distributed over multiple nodes that pass the messages. The advantages of the networked nodes include efficient channel utilization, enhanced noise immunity, ease of reconfiguration, and crucially, a much lower price.

An advantage of model-based adaptive nodes is the performance-scaling inherent in the use of computational models for the System ID. Typically, the portion of the overall state space of the plant that can be effectively controlled is limited by the availability of models matched to the associated dynamics. Generally, the more varied the models, the wider the operating range of the plant.

Consider the case of a simple vertical column, under an axial load, and actively stabilized by a platform that uses models as shown in FIGS. 5A-5C. Each of these models is specialized for the dynamics of a particular combination of boundary condition and excitation of the plant.

The model of FIG. 5A corresponds to a column that is hinged on both ends and that is loaded statically.

The model of FIG. 5B is for a column that is also statically loaded, but where the bottom end is fixed.

The model of FIG. 5C is for a column with two fixed ends, and where the load is a dynamic impact.

For each of these three models, the platform employs a dedicated control law. For the overall platform to function, the nodes of the platform select the correct model (System ID), and execute the associated control law, i.e., the feedback control process.

Within an assigned operating domains, each control law insures the stability of the plant. But for a single column to withstand all three operating conditions in sequence, all three models must be available. A case in point is a column that is initially hinged on both ends and bearing a static load, but where the bottom hinge becomes blocked, or where the load is augmented with an impact.

One fundamental limitation is the compute load of the System ID function. As the number of models increases, the compute load increases. Ultimately, the System ID computation slows to the point where it can no longer meet the latency requirements for the feedback.

For networked MIMO nodes, this limitation translates to a limitation on the ability to efficiently distribute the System ID computation, which the invention solves.

Thus, the invention relates to model-based adaptive control implemented on networked MIMO nodes. Although, the capability and potential of these types of nodes is understood, the performance of prior art nodes is limited by a combination of the compute requirements of the computational models and the general limitations of concurrent programming: reliability, scalability, tolerance to HW failure, scheduling, synchrony, and load balancing.

Therefore, the invention comprises a method and system for altering the dynamic response of physical mechanical systems (plants) under virtual control. The methods of the invention relate to self-configuring software as applied to platforms with distributed MIMO nodes.

The control procedures of the MIMO nodes are implemented as ensembles of independent software modules. The software modules are spatially distributed throughout these platform in such a way that the nodes efficient use of available resources. The spatial distribution of the software modules can be made optimal relative to selected system performance criteria as described above. The control procedure automatically adapts to changes in the number or placement of the control elements.

The invention enables advances in feedback control systems, particularly in systems where the performance of prior art systems is limited by issues of portability, scaling, sensitivity to hardware failure, or post-deployment reconfiguration of the underlying control hardware.

Node Architecture

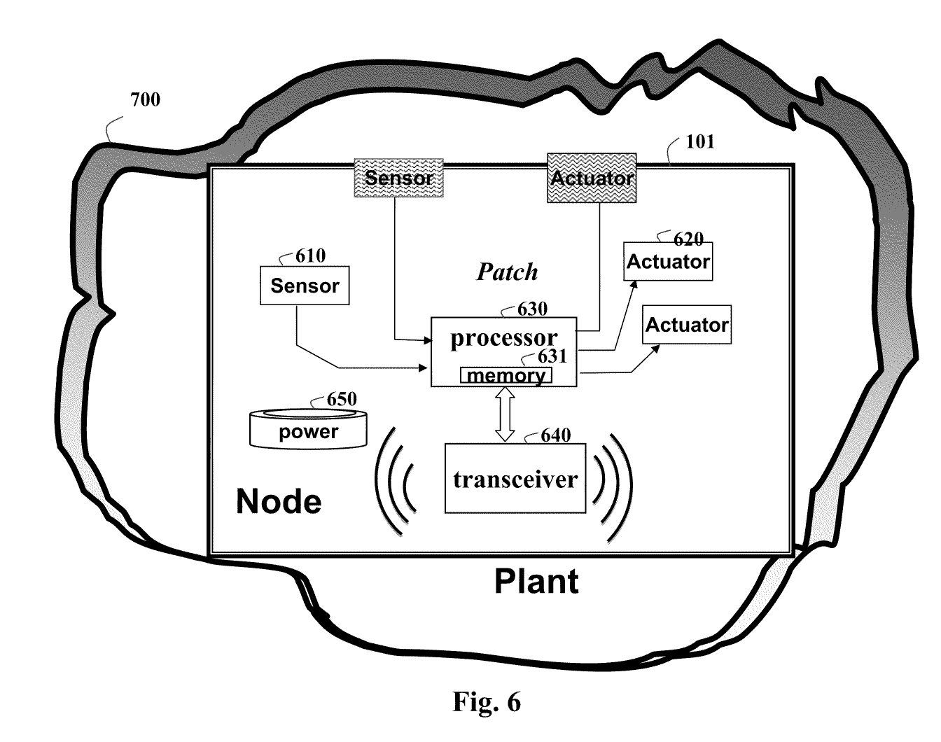

FIG. 6 a node 101 according to embodiments of the invention. The node includes the processor 630 connected to the set of sensors 610, the set of actuators 620, the transceiver 640, and the power source 650. The sets can have any number of sensors and actuators, including none (the null set. The transceiver includes a transmitter and a receiver. Physical connectivity can be either wired and/or wireless. The processor includes the memory 631 for storing software and data. The memory can also be external to the processor.

The sensors measure the physical phenomena 100 The actuators are designed to dynamically control the plant in response to the phenomena. For example, if the plant is a planar surface, and the phenomenon is an incident sound wave, then the desired response could be to cancel a reflection of the sound wave.

The sensor can be a capacitive pressure sensor, and the actuator can be a planar material with a dynamically variable stiffness capable of absorbing the incident sound waves at selected frequencies. The networked node can analyze the sensor data, model the incident wavefront, select the portion of the audio spectrum to absorb, and sequence the actuators.

Alternatively, the node can enable dynamic variation of properties of bulk materials, such as steel or concrete. A simple example is the Young's modulus, which is a constant ratio of stress over strain given by Hooke's law. Consider a material with a constant Young's modulus that is covered with small sensors and actuators that can sense stress and apply a locally restoring force. Within the limited range of the actuators, the material can be made to appear to have a different Young's modulus.

For purposes of this description, two characteristics distinguish the structure of our nodes. The first is that the sensors and actuators are proximate to the processor and portions of the plan. For the common case where sensors generate an analog signal, which is digitized, minimizing a length of the analog signal paths is an effective approach for reducing coupling noise. The second distinguishing characteristic is that the processing power and storage of the processor is small when compared to the requirements of the feedback control process. Therefore, the processing is necessarily distributed over multiple nodes.

Distributed Platform

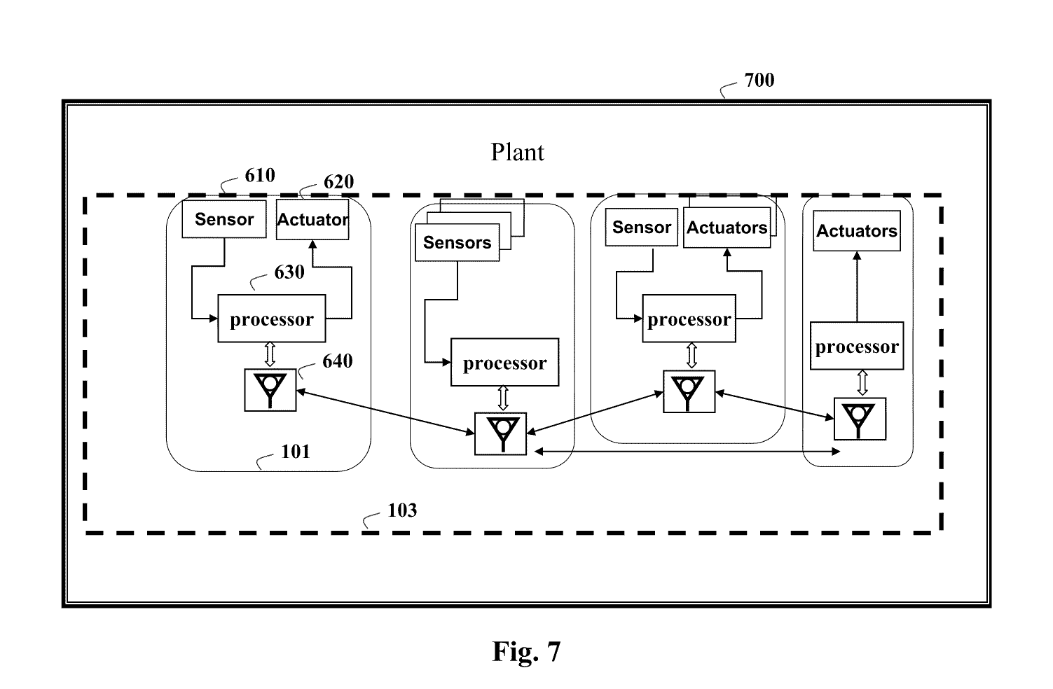

FIG. 7 shows the plant 700, and multiple nodes 101 comprising the platform 103 embedded in the plant. By being the embedded, the nodes can be inside or on surfaces of the plant. The following characteristics distinguish the physical architecture of the platform and the plant. The nodes are heterogeneous in that the sets of sensors and actuators can vary in number and type. The placement of the nodes in number, length scale and regularity corresponds to characteristics of the plant.

The networked processors are treated as a single parallel processing platform. Feedback control process is implemented for concurrent execution on this distributed platform. Neighboring nodes exchange message as long as bandwidth and propagation constraints are not violated. The speed at which messages propagate between the nodes is greater than a propagation speed of the phenomena that is sensed and controlled in the plant.

The platform is self-configuring at start-up, and dynamically reconfigures in response to the addition or removal of nodes. The performance of platform is scalable in the execution time, power efficiency, precision of state estimates. Performance increases smoothly with the inclusion of additional nodes. Conversely, as nodes are removed or fail, the performance degrades smoothly.

Feedback Control

The invention comprises application of methods for self-configuring software to the problem of feedback control running on a network of distributed nodes.

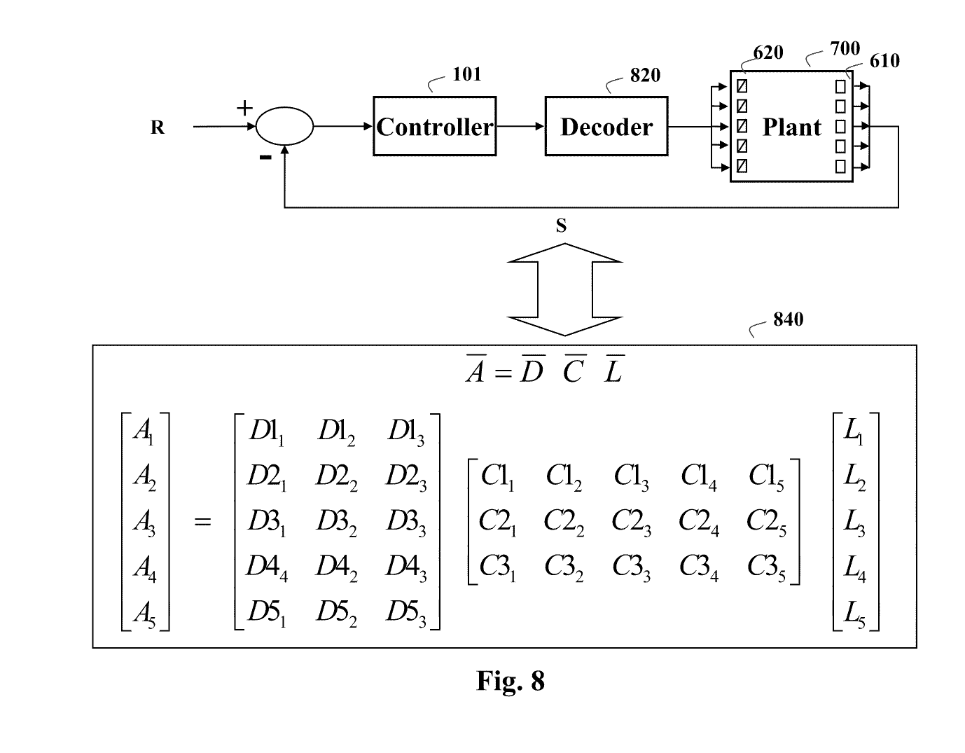

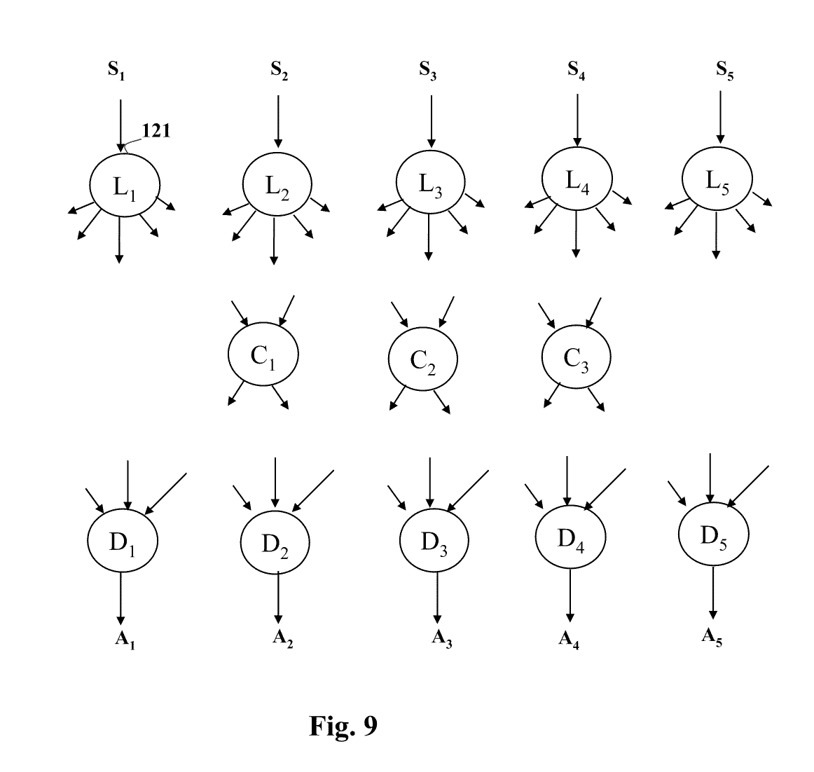

FIGS. 8 show an implementation of a proportional-integral-derivative (PID) procedure into an ensemble of the saObjects, and a corresponding run time application.

FIG. 8 shows the node 101, decoder 820 for messages, the plant 700, and control matrix 840 for five sensor inputs 620 used to drive the five actuator outputs 630. A vector L̅ is a band limited difference between normalized sensor inputs, and an external reference signal. Multiplication produces a three-component model C̅ of the state of the plant. A matrix D̅ translates this model into drive values for each of the five actuators Ā.

FIG. 9 represents this PID node as a graphical model. Each node in the graph embodies a subset of the overall matrix computation of FIG. 8. At each node, input arrives in the form of messages s. A function is applied to produce a result, and the result is coded as messages that proceed along the edges of the graph to the destination nodes. This representation as a graphical model is independent of the spatial distribution of the nodes.

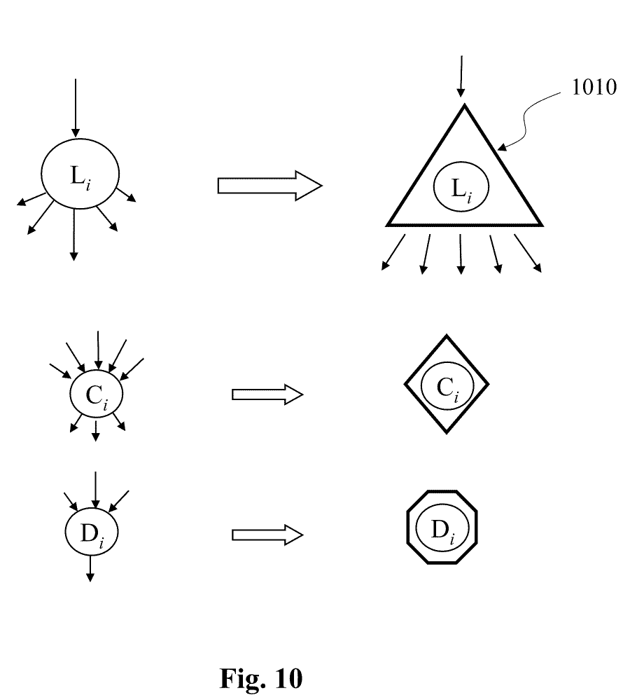

In FIG. 10, the functions of FIG. 9 are encoded as saObjects for distribution on the parallel computing platform. These saObjects can be regarded as a position-independent functions embedded in a SW “wrapper” 1010, which includes a cost function, a network interface, and the API. The task of this SW wrapper is to select a spatial location for the saObject, and to provide network interface for incoming and outgoing messages.

In one embodiment of the invention, the saObjects select the spatial location on the platform based on messages exchanged with other spatially proximal saObjects. In this embodiment, while the message exchange is strictly local, the resulting global distribution can be optimal in accordance with a given cost function, e.g., maximal or minimal power consumption.

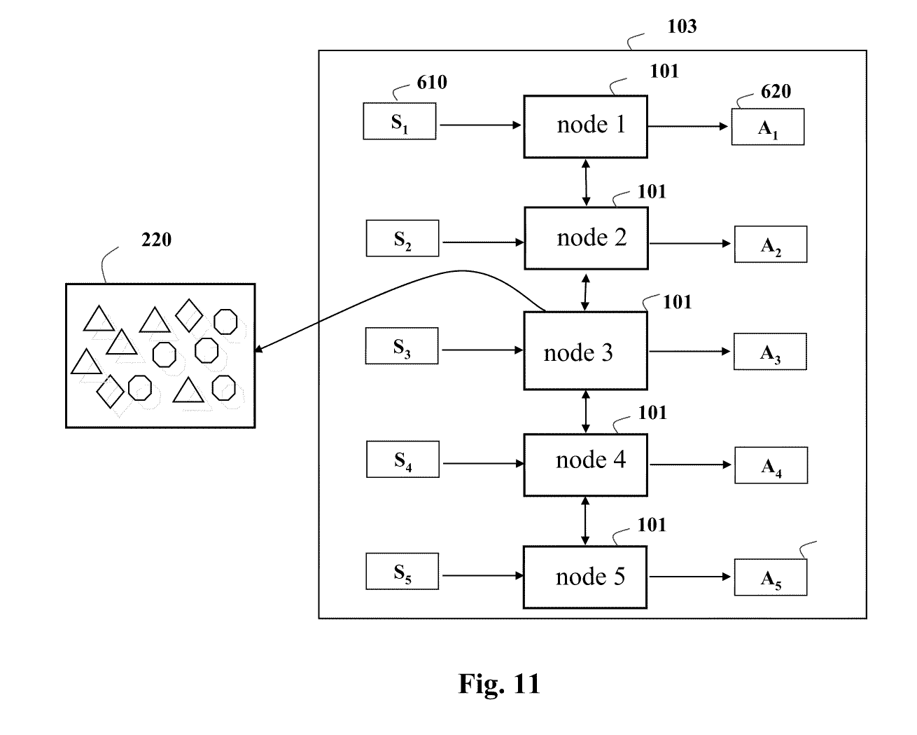

FIG. 11 shows a nm time example operating on a distributed platform 1100 of five networked nodes 101 arranged in a 1D cascade. Each node 101 includes element that integrates sensing, actuation, processing, and support for network connectivity to neighboring nodes. Each node 101 senses data sensors Sᵢ 610, and drives the actuators Aᵢ 620.

FIG. 11 also shows a plausible initial distribution of the thirteen saObjects 1110. In this example, all of the saObjects 220 are assigned to the middle node. While this is computationally equivalent to other distributions, the network delay and disproportionate compute loading make this configuration extremely inefficient.

The embodiments of the invention collectively reposition the saObjects during operation into a configuration that minimizes a predetermined cost.

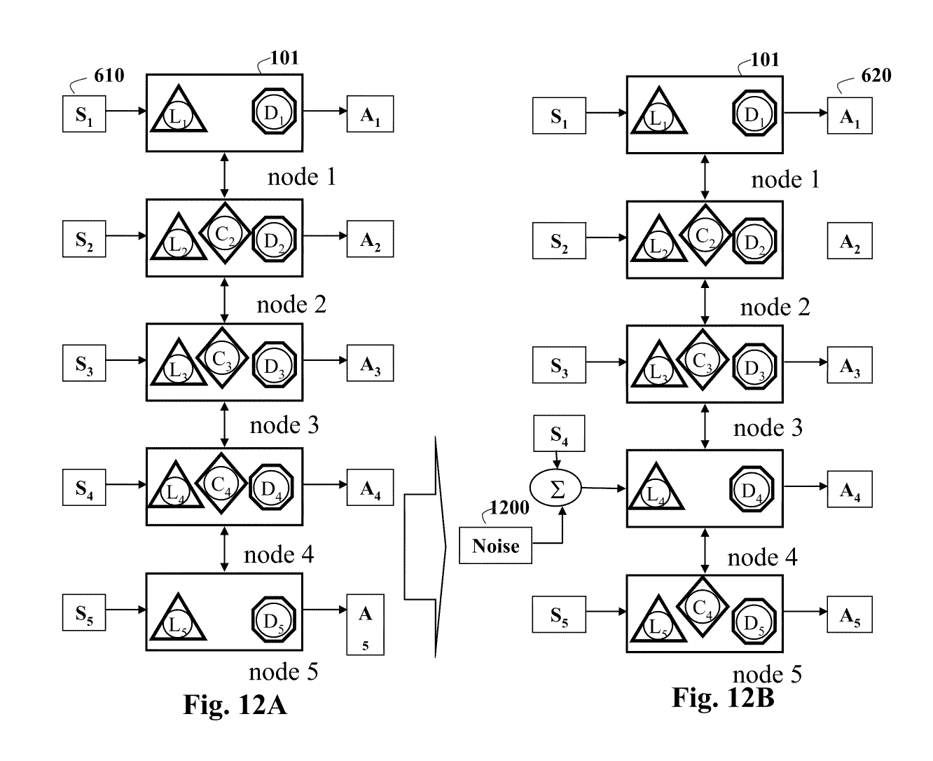

FIGS. 12A and 12B illustrate the distribution that results when the saObjects are arranged to minimize a response time. The saObjects containing the sensor preprocessing functions L̅ and the actuation drive calculations D̅ transfer to the nodes containing the associated HW (sensors and actuators). The saObjects that implement the state estimation, C̅, transfer to those nodes that have an optimal trade off of available compute capacity and message latency.

FIG. 12A shows the distribution that results when the compute capacity of the nodes is roughly equivalent. In such a case, the C̅ saObjects are arranged so that the network delay for the compute time is minimized. The rearrangement process can be repeated automatically to adapt for changes in the topology or in the run time performance of the HW platform.

In the example of FIG. 12B, the sensor of HW node 4 is degraded by noise 1200. One response can be to partially compensate with signal processing executing locally on node 4, which reduces the available compute capacity of node 4, triggering a rearrangement of the saObject C3 to node 5. This rearrangement is driven by the distributed cost function that favorably weighs the increase in compute capacity available to C3 against an increased transmission delay.

Scaling System Performance

In one embodiment of the invention, the System ID function uses computational models to represent the state of the system. In such a case, effective estimation of state requires the selection of a suitably parameterized model from a set of available models. The selected model supports a “best” fit to the observed data, where a “goodness” of the fit is determined using a selectable criteria.

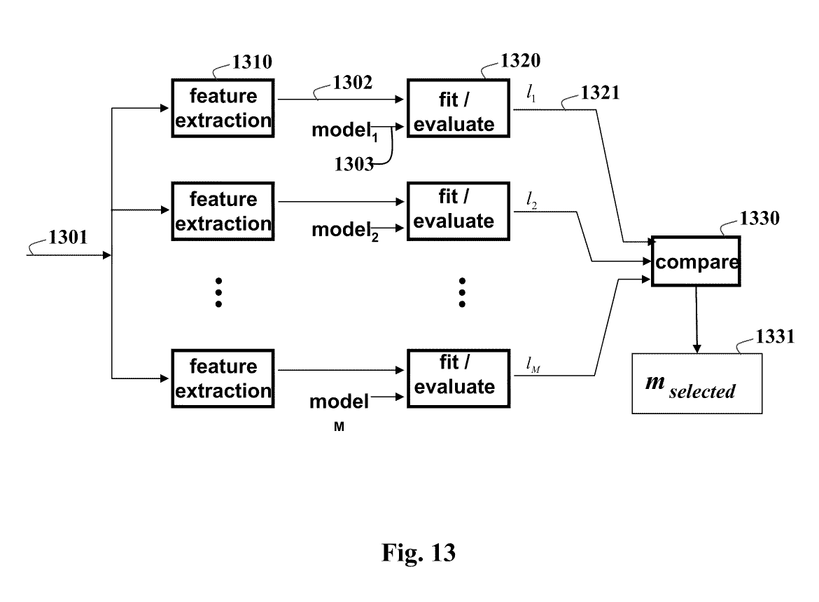

As shown in FIG. 13, this operation can be cast as a search through a space of available models using a classifier. Given an input vector 1301 and the set of models 1303, the goal of the classifier is to determine a parameterized version of the model that best approximates the data in the input vector. The model selection is represented as a set of parallel paths.

Features 1302 are extracted 1310 from the input vector 1301 to reduce dimensionality and/or to select salient characteristics of the sensed signal. A function fitting/evaluation stage 1320 parameterizes each model 1303 for an optimal fit to the input data. The “goodness” of this fit is evaluated and used to quantify a likelihood l 1321 of the model given the input data. A compare operation 1330 selects the optimal model m_{selected} 1331 based on the likelihood, and returns an index of the selected model, and the associated parameters

With an increase in the number and variety of models, the operating range and/or accuracy of the System ID function increases. However, the search operation is bounded by the compute capacity. The FIG. 13 suggests a distribution of the computation for concurrent processing. Separate components of the classifier can be represented as individual saObjects. Distribution of the saObjects can be driven by a distributed optimization operating on a cost function that balances the compute loads on the nodes against the delay in the network.

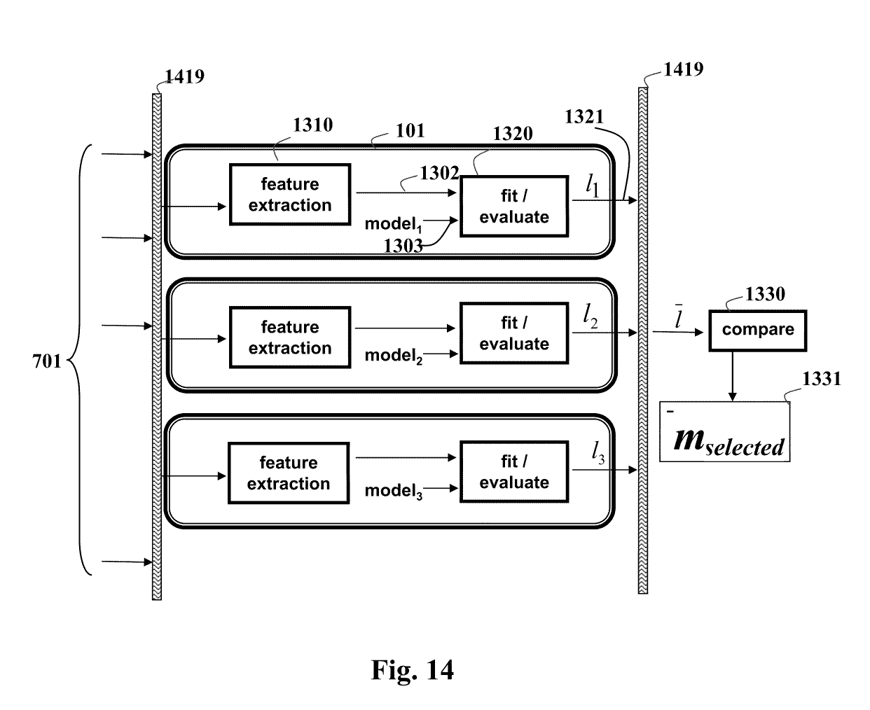

FIG. 14 shows how the model selection can be distributed over multiple nodes 101 by passing message via nearest neighbor links 1419. Multiple nodes sample the sensors, encode the data as messages, and then broadcast the data using the messages. Each node stores a model, aggregates the messages into the vector, extracts the feature vector, fits the model to the data, determines the model's likelihood given the data, encodes the likelihood as a message, and broadcasts the message. The procedure to compare 1330 and select 1331 the representative model is likewise embodied as the saObject stored in the node.

In this embodiment of the invention, the aggregate compute capacity of the node increases with the number of nodes, and the PSA programming model enables efficient distribution of the search operation over the nodes. As more nodes are added, the capacity to search over a larger model space is added.

This scaling performance is a material advance over the prior art.

### Effect of the Invention

This invention adapts programming techniques from the field of multi-agent systems to the problem of parallel execution of a model-based control law on a network of nodes embedded in a physical dynamic system (plant). Feedback control procedures are implemented as ensembles of independent software modules, which exchange messages to models over nodes. This distribution process can be driven by unsupervised local interaction among the software modules, and is therefore not bound by the limits inherent in centralized control architectures.

Control laws implemented in this manner exhibit novel degrees of performance scaling, error resilience and portability across node. In the context of adaptive model-based control, this means that the number and variety of computational models can be achieve a desired level of hardware parallelism. For the control architectures described herein, this is especially enabling.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for controlling a plant using feedback signals, comprising the steps of:
translating a procedural description of a feedback control process for the plant into a set of objects, wherein each object is a portion of the procedural description, wherein each object is a strictly-encapsulated and autonomous software module, wherein the objects execute in a platform, and the platform includes a set of nodes embedded in the plant and each node includes a processor; and
generating the feedback signals by passing messages between the set of the objects in response to an operation of the plant.

2. The method of claim 1, further comprising:
measuring the operation of the plant with a set of sensors connected to the nodes;
sending the feedback signals to a set of actuators connected to the set nodes to control the operation of the plant.

3. The method of claim 1, wherein the plant is subject to dynamic physical phenomena, and a speed at which the feedback signals are generated is greater than a speed at which the phenomena propagate though the plant.

4. The method of claim 1, further comprising:
organizing the set of nodes into subsets of nodes, wherein a reference node each subset has direct communication links to all nodes in the subset.

5. The method of claim 1, wherein a degree-of-freedom (DOF) of the platform depends on a number of the nodes, an interconnect hierarchy, and a network topology, which includes node placement, node density, node regularity, and an interconnectivity configuration.

6. The method of claim 5, wherein the DOF includes mechanical DOF and information DOF.

7. The method of claim 1, wherein each node has a sub-cm² footprint, and the number of nodes is in a range 10¹ to 10⁶.

8. The method of claim 1, further comprising:
optimizing a performance of the platform and a distribution of the set of nodes according to a gradient descent cost function subject to constraints.

9. The method of claim 8, wherein the performance includes throughput, latency, memory size, power consumption, and redundancy.

10. The method of claim 1, further comprising:
adapting the feedback control process to the operation of the plant.

11. The method of claim 8, wherein an initial distribution of the objects over the nodes is random, and further comprising:
reconfiguring dynamically the objects in response to the operation of the plant.

12. The method of claim 11, wherein the reconfiguring is due to failure of any of the nodes, adding of nodes, removal of nodes, and changes in a computational capacity of any of the nodes.

13. The method of claim 8, further comprising:
distributing the a gradient descent cost function over the set of nodes.

14. The method of claim 1, wherein a spacing between the nodes is small compared to characteristic length scales of dynamic of the plant.

15. The method of claim 1, further comprising:
encoding the feedback control process according to process self-assembly (PSA) models.

16. An apparatus for controlling a plant using feedback signals, comprising:
a platform including a plurality of node, wherein the nodes are embedded in the plant and each node includes a processor;
means for translating a procedural description of a feedback control process for the plant into a set of objects, wherein each object is a portion of the procedural description, wherein each object is a strictly-encapsulated and autonomous software module, wherein the objects are configures to execute in the nodes; and
means for generating the feedback signals by passing messages between the set of the objects in response to an operation of the plant.

17. The apparatus of claim 16, further comprising:
a set of sensors configured to measure the operation of the plant; and
a set of actuators configured to process the feedback signals, wherein the set of sensors and the set of nodes are connected to the nodes.

18. The apparatus of claim 16, wherein the plant is subject to dynamic physical phenomena, and a speed at which the feedback signals are generated is greater than a speed at which the phenomena propagate though the plant.

19. The apparatus of claim 16, wherein the of nodes are organized into subsets of nodes, wherein a reference node each subset has direct communication links to all nodes in the subset.

20. The apparatus of claim 16, wherein each node has a sub-cm² footprint, and the number of nodes is in a range 10¹ to 10⁶.

21. The apparatus of claim 16, wherein a performance of the platform and a distribution of the set of nodes is optimized according to a gradient descent cost function subject to constraints.

22. The apparatus of claim 16, wherein an initial distribution of the objects over the nodes is random, and wherein the objects reconfigure dynamically in response to the operation of the plan.

23. The apparatus of claim 16, wherein a spacing of the nodes is relatively small compared to characteristic length scales of dynamics of the plant.

24. The apparatus of claim 16, wherein a performance of the platform scales up according to a number of the nodes.
